(19) United States
(12) Patent Application Publication
(10) Pub. No.: US 2011/0075204 A1
(43) Pub. Date: Mar. 31, 2011

(54) IMAGE FORMING SYSTEM, IMAGE FORMING APPARATUS, AND IMAGE FORMING APPARATUS MANAGEMENT METHOD

(75) Inventor: Sachiko Yoshimura, Osaka (JP)

(73) Assignee: KYOCERA MITA CORPORATION

(21) Appl. No.: 12/879,545

(22) Filed: Sep. 10, 2010

(30) Foreign Application Priority Data
Sep. 30, 2009 (JP) 2009-226133

(51) Int. Cl. G06F 3/12

(52) U.S. Cl. 358/1.15

(57) ABSTRACT

Provided is an image forming system, including an image forming apparatus connected to a communication network and a server connected to the communication network. The image forming apparatus includes a management service processing unit that transmits a registration request for registering the image forming apparatus as a target of a management service to the server. The server includes a data management unit that receives the registration request and registers the image forming apparatus that has transmitted the registration request as the target of the management service. The management service processing unit periodically collects device information including a state and/or a setting of the image forming apparatus and transmits the device information to the data management unit. The data management unit periodically acquires the device information from the management service processing unit and retains the device information.

### INCORPORATION BY REFERENCE

This application is based upon and claims the benefit of priority from corresponding Japanese Patent Application No. 2009-226133, filed in the Japan Patent Office on Sep. 30, 2009, the entire contents of which is incorporated herein by reference.

### BACKGROUND

1. Field of the Invention

The present invention relates to an image forming system, an image forming apparatus, and an image forming apparatus management method.

2. Description of the Related Art

One known system monitors an internal state of an image forming apparatus such as a printer, a copier, or a multifunction peripheral. An external apparatus then acquires the internal state of the image forming apparatus.

Another system allows remote monitoring of a plurality of apparatus connected to a network.

According to the above-mentioned technology, in order to monitor a plurality of image forming apparatus connected to the network, an administrator or a service person needs to register the plurality of image forming apparatus as monitor targets. Further, if the monitored plurality of image forming apparatus have mutually different models, the monitor settings work are different among the monitor targets, complicating the monitoring performed by the administrator or the service person. This increases the workload for the administrator or the service person.

### SUMMARY

This disclosure relates to an image forming system that may monitor a plurality of image forming apparatus connected to a network without requiring a heavy workload for an administrator or a service person, and an image forming apparatus that may be used for the image forming system.

An image forming system according to the present disclosure includes an image forming apparatus connected to a communication network and located at a customer's facilities and a server connected to the communication network and located at a different location, such as a management service center. The image forming apparatus includes a management service processing unit configured to transmit a registration request for registering the image forming apparatus as a target of a management service to the server when a registration request operation is input through a user interface for a customer. The server includes a data management unit configured to receive the registration request and registers the image forming apparatus that has transmitted the registration request as the target of the management service. The management service processing unit periodically collects device information, including at least one of a state and a setting of the image forming apparatus, and transmits the device information to the data management unit. The data management unit periodically acquires and retains the device information from the management service processing unit.

An image forming apparatus according to the present disclosure includes (1) a communication device that is connected to a communication network and allows communications with a server located in a management service center and (2) a management service processing unit configured to transmit a registration request for registering the image forming apparatus as a target of a management service to the server when a registration request operation is input through a user interface of a customer. The management service processing unit periodically collects device information including at least one of a state and a setting of the image forming apparatus and transmits the device information to the server.

An image forming apparatus management method according to the present disclosure includes transmitting a registration request for registering an image forming apparatus as a target of a management service to a server when a registration request operation is input through a user interface of the image forming apparatus. The server receives the registration request and registers the image forming apparatus that has transmitted the registration request as the target of the management service. Device information, including at least one of a state and a setting of the image forming apparatus, is periodically collected and transmitted to the server.

Additional features and advantages are described herein, and will be apparent from the following Detailed Description and the figures.

### BRIEF DESCRIPTION OF THE DRAWINGS

In the accompanying drawings:

FIG. 1 is a block diagram illustrating a configuration of an image forming system according to an embodiment of the present invention;

FIG. 2 is a sequence diagram that describes registration of an image forming apparatus performed in a management service by the image forming system illustrated in FIG. 1;

FIG. 3 is a sequence diagram that describes acquisition and updating of device information on the image forming apparatus performed in the management service by the image forming system illustrated in FIG. 1;

FIG. 4 is a sequence diagram that describes viewing of the device information on the image forming apparatus performed in the management service by the image forming system illustrated in FIG. 1; and

FIG. 5 is a sequence diagram that describes registration deletion for the image forming apparatus performed in the management service by the image forming system illustrated in FIG. 1.

### DETAILED DESCRIPTION

Hereinafter, described is an embodiment of the present invention with reference to the accompanying drawings.

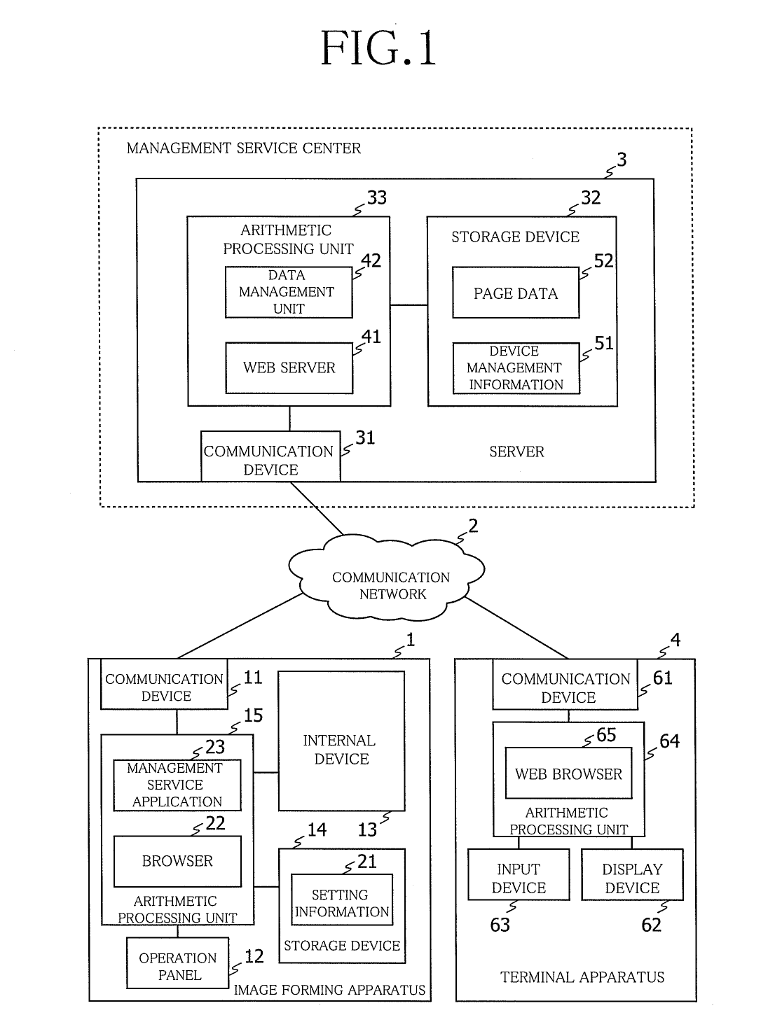

FIG. 1 is a block diagram illustrating a configuration of an image forming system according to an embodiment of the present invention. In the image forming system, an image forming apparatus 1 is connected to a communication network 2 to which a server 3 and a terminal apparatus 4 are connected. Examples of the communication network 2 include the Internet and an intranet.

The image forming apparatus 1 is an apparatus located in a customer's facilities, which is set as a monitor target of a management service. The server 3 is an apparatus located in a management service center, which performs the management service for the registered image forming apparatus. The terminal apparatus 4 is an apparatus located in the customer's facilities, which accesses the server 3 for viewing at least one of a state and a setting of the image forming apparatus 1 of the customer. The management service is a service in which the server 3 acquires at least one of the state and the setting of the image forming apparatus 1 periodically on a predetermined schedule and notifies of the at least one of the state and the setting of the image forming apparatus 1 in response to a request.

The image forming apparatus 1 is an apparatus such as a printer, a copier, or a multifunction peripheral, and includes a communication device 11, an operation panel 12, an internal device 13, a storage device 14, and an arithmetic processing unit 15.

The communication device 11 is a device connected to the communication network 2 that allows data communications to be performed with the other apparatus connected to the communication network 2. Examples of the communication device 11 include a network interface and a modem.

The operation panel 12 is located in a casing of the image forming apparatus 1 and includes a display device and an input device. Examples of the display device include a liquid crystal display and various kinds of indicators. Examples of the input device include a touch panel and a key switch.

The internal device 13 includes mechanical components necessary for printing, document image reading, and the like, and an electric control unit that controls the mechanical components.

The storage device 14 is a nonvolatile storage device including a nonvolatile memory and a hard disk drive. Stored in the storage device 14 is setting information 21 on the internal device 13, an operation screen displayed on the operation panel 12, and the like.

The arithmetic processing unit 15 is a device including a central processing unit (CPU), a read only memory (ROM), and a random access memory (RAM), that implements various kinds of processing units using the CPU executing programs stored in the ROM, the storage device 14, and the like. The arithmetic processing unit 15 implements a browser 22 and a management service application 23. For example, the arithmetic processing unit 15 may implement a JAVA virtual machine and implement the management service application 23 as a JAVA application running on the JAVA virtual machine.

The browser 22 controls the operation panel 12 to display on the display device of the operation panel 12 various kinds of operation screens and various kinds of information. Further, the browser 22 detects a user's operation through the input device of the operation panel 12. In this embodiment, the browser 22 and the operation panel 12 constitute a user interface for the customer.

If a registration request operation is input through the user interface, the management service application 23 controls the communication device 11 to transmit a registration request for registering the image forming apparatus 1 as a target of the management service to the server 3. After registration, in response to the request received from the server 3, the management service application 23 periodically collects device information including at least one of the states and the setting of the image forming apparatus 1 and transmits the device information to the server 3. In addition, the management service application 23 has a hypertext transfer protocol (HTTP) client function. To display a screen on the operation panel 12, the management service application 23 acquires page data from the server 3 and supplies the page data to the browser 22.

The state of image forming apparatus 1 is acquired from the internal device 13. The setting of the image forming apparatus 1 is acquired from the setting information 21. For example, in a case where the internal device 13 has a printer function, information including a remaining amount and a use amount of a consumable item such as paper or toner (various kinds of counter values of print, scan, copy, facsimile, and the like), a cumulative operation time, and an operation time slot is detected as the state of the image forming apparatus 1. Further, an operating state (such as “normal” or “error occurred”) of the image forming apparatus 1 is detected as the state of the image forming apparatus 1. For example, in the case where the internal device 13 has the printer function, information including the presence/absence and type of a finisher and the presence/absence and type of an additional function is detected as the setting of the image forming apparatus 1.

The server 3 includes a communication device 31, a storage device 32, and an arithmetic processing unit 33.

The communication device 31 is a device connected to the communication network 2 that allows the data communications to be performed with the other apparatus connected to the communication network 2. Examples of the communication device 31 include a network interface and a modem.

The storage device 32 is a nonvolatile storage device including a nonvolatile memory and a hard disk drive. Stored in the storage device 32 are device management information 51 and page data 52.

The device management information 51 includes information in which identification information on the registered image forming apparatus, identification information on (for example, user ID and password of) the customer (user) of the image forming apparatus 1, and device management information including at least one of the state and the setting of the registered image forming apparatus are associated with one another.

The page data 52 is data on the screen displayed on the image forming apparatus 1. Hypertext markup language (HTML) data is preferably used here as the page data 52.

The arithmetic processing unit 33 includes a CPU, a ROM, and a RAM, and implements various kinds of processes by the CPU executing programs stored in the ROM, the storage device 32, and the like. The arithmetic processing unit 33 implements a web server 41 and a data management unit 42. The web server 41 has an HTTP server function, and upon reception of an HTTP command from HTTP clients on the image forming apparatus 1 or the terminal apparatus 4, transmits data corresponding to the HTTP command. Further, the data management unit 42 receives the registration request from the management service application 23, and registers the image forming apparatus 1 that has transmitted the registration request as the target of the management service. After the registration, the data management unit 42 acquires the device information from the management service application 23 periodically on the predetermined schedule, and updates the device management information 51.

Further, the terminal apparatus 4 includes a communication device 61, a display device 62, an input device 63, and an arithmetic processing unit 64. For example, a personal computer is used as the terminal apparatus 4.

The communication device 61 is a device connected to the communication network 2 that allows the data communications to be performed with the other apparatus connected to the communication network 2. Examples of the communication device 61 include a network interface and a modem.

The display device 62 is a device that displays various kinds of information. For example, a liquid crystal display is used as the display device 62. The input device 63 is a device that receives a user's operation. For example, a keyboard and a mouse are used as the input device 63.

The arithmetic processing unit 64 includes a CPU, a ROM, and a RAM, and implements various kinds of processes by the CPU executing programs stored in the ROM and the like. The arithmetic processing unit 64 implements a web browser 65. The web browser 65 is an HTTP client, and is used for viewing the device information on the image forming apparatus 1 registered in the server 3.

Next described is an operation of the above-mentioned apparatus.

Here, described are (A) registration of the image forming apparatus 1, (B) acquisition and updating of the device information on the image forming apparatus 1, (C) viewing of the device information for the image forming apparatus 1, and (D) registration deletion for the image forming apparatus 1, which are performed in the management service.

(A) Registration of the Image Forming Apparatus 1

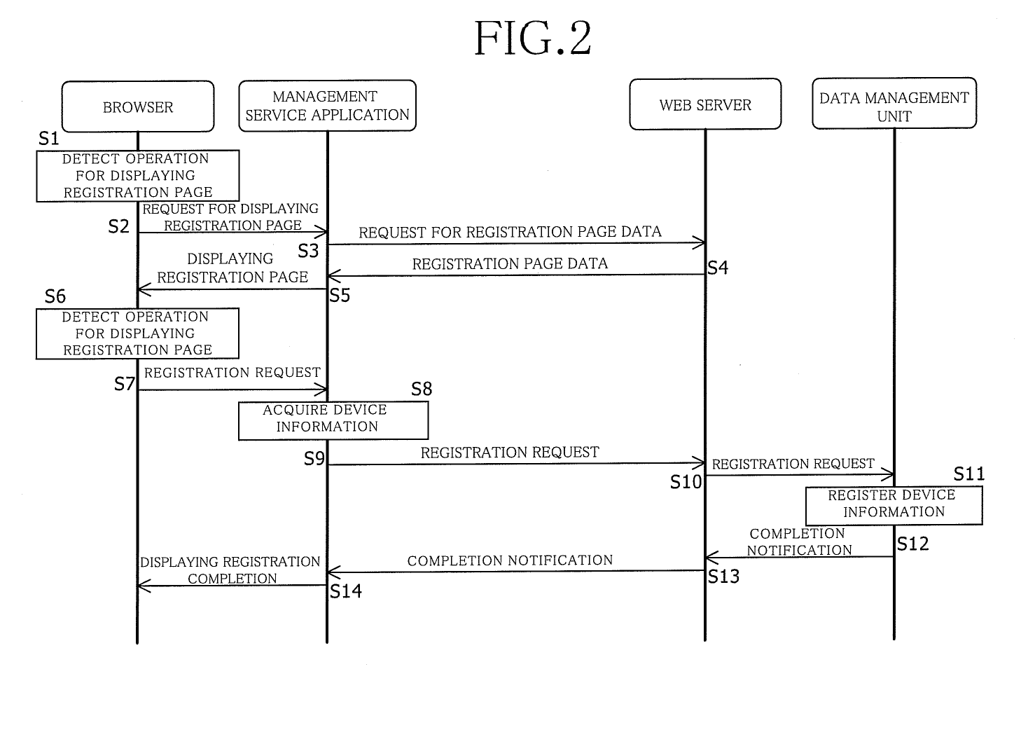

The registration of image forming apparatus 1 is executed when a predetermined operation is performed by the user with respect to the image forming apparatus 1. FIG. 2 is a sequence diagram that describes the registration of the image forming apparatus performed in the management service by the image forming system illustrated in FIG. 1.

On the image forming apparatus 1, the browser 22 displays a menu screen on the operation panel 12. When an operation for displaying a registration page for the image forming apparatus 1 is performed on the menu screen, the browser 22 detects the operation (Step S1). Then, the browser 22 notifies the management service application 23 of the detection of the operation (Step S2).

The management service application 23, which has been notified thereof, uses the communication device 11 to transmit a request for registration page data to the web server 41 of the server according to HTTP (Step S3). The web server 41 uses the communication device 31 to receive the request, reads the registration page data corresponding to the request among the page data 52, and transmits the data to the management service application 23 (Step S4).

When the management service application 23 receives the registration page data, the browser 22 displays the registration page on the operation panel 12 based on the registration page data (Step S5). When the operation for the registration of the image forming apparatus 1 is performed after the registration page is displayed, the browser 22 detects the operation (Step S6). Then, the browser 22 notifies the management service application 23 of the detection of the operation (Step S7). At this time, information on the user including the user name, an e-mail address, a telephone number, an address, and a password, and additional information including a service charge payment method may be input through the registration page, and may be registered on the server 3 along with the identification information on the image forming apparatus 1.

The management service application 23, which has been notified thereof, acquires the setting information 21 and the state of the internal device 13 as the device information in terms of a predetermined item (Step S8). The management service application transmits the registration request, the identification information for the image forming apparatus 1, the identification information (e.g., user name and password) for the user, the other additional information, and the device information to the web server 41 of the server 3 (Step S9). The registration request is performed by the HTTP command.

The management service application 23 calls an application program interface (API) prepared before acquiring the device information.

On the server 3, upon receiving the registration request and information thereon, the web server 41 causes the data management unit 42 to execute the registration of the image forming apparatus 1 (Step S10). The data management unit 42 adds the identification information for the image forming apparatus 1, the identification information for the user, and the device information to the device management information 51, and registers the image forming apparatus 1 as the monitor target of the management service (Step S11). The identification information for the image forming apparatus 1 includes identification information within the communication network 2, such as a URL and an IP address thereof. The data management unit 42 may reference the device management information 51 to determine whether or not the image forming apparatus 1 corresponding to the registration request has already been registered, to thereby avoid duplicate registration. The data management unit 42 may reject the registration if necessary information is not received along with the registration request.

Then, upon completing the registration, the data management unit 42 notifies the web server 41 thereof (Step S12). The web server 41 transmits a response to the management service application 23 indicating that the registration has been completed (Step S13).

On the image forming apparatus 1, when the management service application 23 receives the response to the registration request, the browser 22 displays a message indicating registration completion on the operation panel 12 (Step S14).

The image forming apparatus 1 is thus registered by the user's operation in the server 3 as the monitor target of the management service.

In the registration, the management service application 23 may transmit model information on the image forming apparatus 1 to be registered to the data management unit 42, and the data management unit 42 may identify the item of the device information on the monitor target. Further, the management service application 23 may notify the data management unit 42 of the item of the device information on the monitor target.

Further, registration user data may be stored in storage device 32 separately from the device management information 51, and the registration of the image forming apparatus 1 may be performed after user authentication for the user is performed.

(B) Acquisition and Updating of the Device Information on the Image Forming Apparatus 1

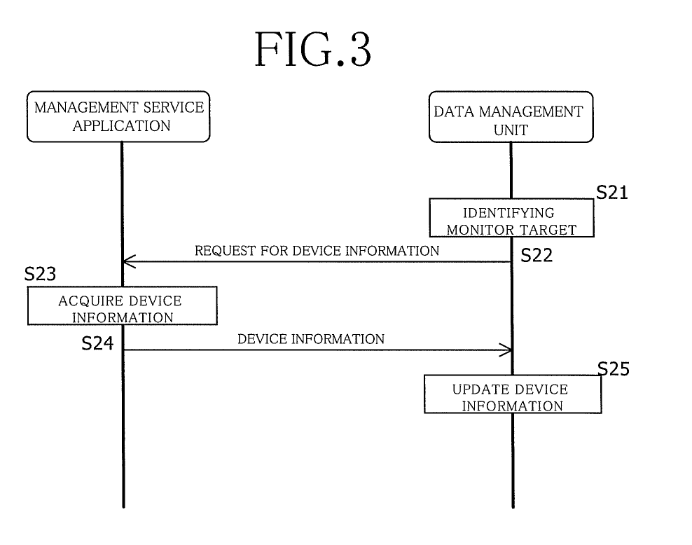

The acquisition and updating of the device information on the image forming apparatus 1 are automatically executed by the server 3 according to a predetermined schedule. For example, the acquisition and updating of the device information are regularly performed at predetermined time intervals such as daily or weekly. The schedule may be specified by the user through the registration page in the registration. FIG. 3 is a sequence diagram that describes the acquisition and updating of the device information for the image forming apparatus performed in the management service by the image forming system illustrated in FIG. 1.

On the server 3, at a timing of the acquisition and updating of the device information, the data management unit 42 first references the device management information 51 to identify which image forming apparatus 1 is the monitor target (Step S21). Then, the data management unit 42 uses the communication device 31 to transmit a device information request to the identified image forming apparatus 1 (Step S22). The device information request is executed via, for example, simple network management protocol (SNMP). Alternatively, the management service application 23 may have a web server function, and the data management unit 42 may transmit the device information request to the URL of the management service application 23 via HTTP.

On the image forming apparatus 1, upon receiving the device information request, the management service application 23 acquires the supplied device information (Step S23). The management service application 23 uses the communication device 11 to transmit a response to the request to the data management unit 42 (Step S24).

On the server 3, upon receiving the device information from the image forming apparatus 1 as the response to the device information request, the data management unit 42 updates the device information for the image forming apparatus 1 within the device management information 51 (Step S25).

Thus the device information on the monitor target is updated in the server 3. Note that, as described above, when an item of the device information for the monitor target is specified, the device information for the monitor target is acquired and updated only in terms of the item.

(C) Viewing of the Device Information for the Image Forming Apparatus 1

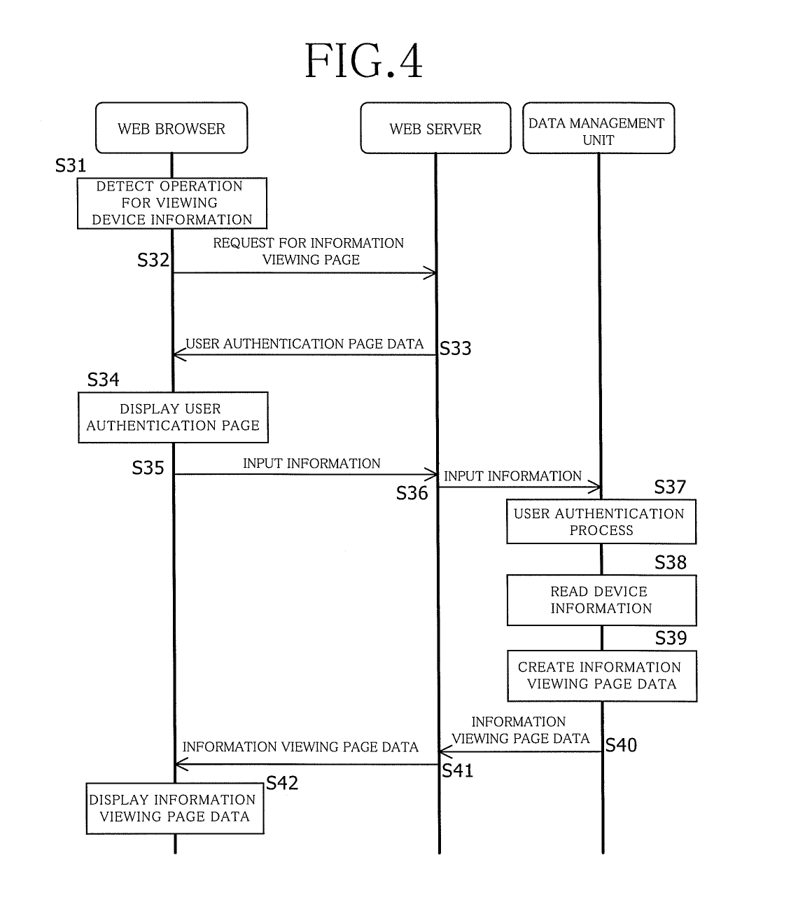

The viewing of the device information for the image forming apparatus 1 is executed when a user's operation is performed on the terminal apparatus 4. FIG. 4 is a sequence diagram that describes the viewing of the device information for the image forming apparatus performed in the management service by the image forming system illustrated in FIG. 1.

On the terminal apparatus 4, when an input of the URL of the web server 41 is received for the purpose of viewing the device information (Step S31), the web browser 65 uses the communication device 61 to transmit a request for an information viewing page to the web server 41 via HTTP (Step S32).

On the server 3, upon receiving the request via the communication device 31, the web server 41 reads user authentication page data from the page data 52 and transmits the user authentication page data to the web browser 65 (Step S33).

On the terminal apparatus 4, upon receiving the user authentication page data, the web browser 65 displays a user authentication page on the display device 62 based on the user authentication page data (Step S34).

When the user operates the input device 63 to input user identification information on the user authentication page, the web browser 65 transmits the input information to the web server 41 (Step S35). When the web server 41 receives the input information, the data management unit 42 acquires the input information (Step S36), and performs a user authentication process (Step S37).

At this time, the data management unit 42 searches the user identification information registered in the device management information 51 for user identification information that matches the input information. If the user identification information that matches the input information does not exist, the data management unit 42 rejects the viewing of the device information, and transmits the response including an error message from the web server 41 to the web browser 65.

On the other hand, if the user identification information that matches the input information exists, the data management unit reads the device information associated with the user identification information (Step S38). Then, the data management unit 42 creates information viewing page data including the device information in HTML (Steps S39 and S40). Then, the web server 41 transmits the information viewing page data to the web browser 65 (Step S41). Upon receiving the information viewing page data, the web browser 65 displays on the display device 62 of the user an information viewing page including the device information for the image forming apparatus 1 based on the information viewing page data (Step S42). At this time, numerical values of respective items of the device information may be displayed in the form of a graph. Further, on the server 3, a history of the device information may be retained and included in the information viewing page.

Based on the above-mentioned input information, the data management unit 42 may determine whether or not the user is a service person, and if the user is a service person, may create detailed information viewing page data for the service person. The user may thus view the device information for his/her own image forming apparatus 1 by operating the terminal apparatus 4.

(D) Registration Deletion for the Image Forming Apparatus 1

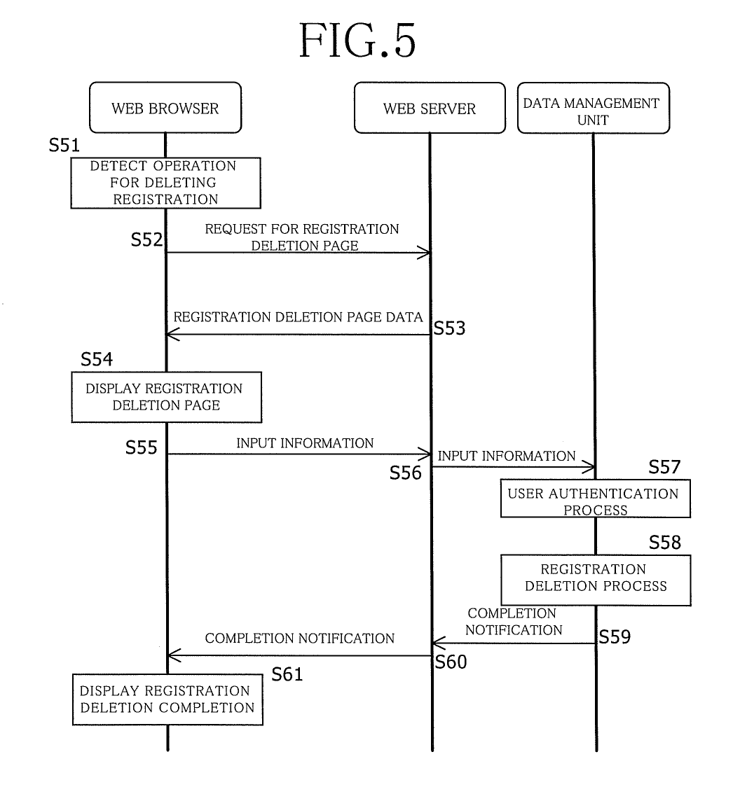

The registration deletion for the image forming apparatus 1 is executed when a predetermined user's operation is performed on the terminal apparatus 4. FIG. 5 is a sequence diagram that describes the registration deletion for the image forming apparatus performed in the management service by the image forming system illustrated in FIG. 1.

On the terminal apparatus 4, when an input of the predetermined URL of the web server 41 is received for the purpose of deleting the registration (Step S51), the web browser 65 uses the communication device 61 to transmit a request for a registration deletion page to the web server 41 via HTTP (Step S52).

On the server 3, upon receiving the request via the communication device 31, the web server 41 reads registration deletion page data from the page data 52 and transmits the registration deletion page data to the web browser 65 (Step S53).

On the terminal apparatus 4, upon receiving the registration deletion page data, the web browser 65 displays the registration deletion page on the display device 62 based on the registration deletion page data (Step S54).

When the user operates the input device 63 to input user identification information on the registration deletion page, the web browser 65 transmits the input information to the web server 41 (Step S55). When the web server 41 receives the input information, the data management unit 42 acquires the input information (Step S56), and performs a user authentication process (Step S57).

At this time, the data management unit 42 searches the user identification information registered in the device management information 51 for user identification information that matches the input information. If the user identification information that matches the input information does not exist, the data management unit 42 rejects the registration deletion, and transmits the response including an error message from the web server 41 to the web browser 65.

On the other hand, if the user identification information that matches the input information exists, the data management unit 42 deletes (1) the user identification information and (2) the identification information and the device information on the image forming apparatus 1 that are associated with the user identification information (Step S58). This inhibits the acquisition of the corresponding device information on the image forming apparatus 1 thereafter.

After completion of the registration deletion, the data management unit 42 creates HTML page data indicating registration deletion completion (Step S59). Then, the web server 41 transmits the page data to the web browser 65 (Step S60). Upon receiving the page data, the web browser 65 displays on the display device 62 a page indicating the registration deletion completion based on the page data (Step S61).

The user may thus delete the registration of his/her own image forming apparatus 1 by operating the terminal apparatus 4.

As described above, the image forming system according to the above-mentioned embodiment includes the image forming apparatus 1 connected to the communication network 2 and located in the customer's facilities, and the server 3 connected to the communication network 2 and located in the management service center. The image forming apparatus 1 includes: the user interface including the operation panel 12 and the browser 22; and the management service application 23 that transmits the registration request for registering the image forming apparatus 1 as a target of the management service to the server 3 when the registration request operation is input through the user interface. The server 3 includes the data management unit 42 that receives the registration request and registers the image forming apparatus that has transmitted the registration request as the target of the management service. The management service application 23 periodically collects the device information including at least one of the state and the setting of the image forming apparatus 1 and transmits the device information to the data management unit 42. The data management unit 42 periodically acquires the device information from the management service application 23 and retains the device information.

Accordingly, the user registers the image forming apparatus 1 as the monitor target, which reduces a workload for the administrator or the service person and allows monitoring of one or a plurality of image forming apparatus connected to the communication network 2. By viewing the device information, the use state of the image forming apparatus 1 may be visualized. Therefore, it is possible to meet the needs of the user interested in energy savings.

Note that the above-mentioned embodiment is a preferred example of the present invention, but the present invention is not limited thereto, and various modifications and changes may be made without departing from the gist of the present invention.

For example, FIG. 1 illustrates one image forming apparatus 1, but a plurality of image forming apparatus connected to the communication network 2 may be monitored in the same manner. In this case, the user may use the terminal apparatus 4 to collectively view the device information for the plurality of image forming apparatus of the user.

In the above-mentioned embodiment, the registration of the image forming apparatus 1 is collectively deleted for a user, but the plurality of image forming apparatus may be registered. In this case, a list of the registered image forming apparatus may be displayed on the user interface. The user may select the image forming apparatus to be subjected to the registration deletion and may delete only the registration of the selected image forming apparatus. Further, only the item of the device information that is selected may be deleted from monitor targets.

In the above-mentioned embodiment, a terminal apparatus through which the service person may view the device information on each of the image forming apparatus may be connected to the communication network 2. This allows the service person to check whether or not a toner outage occurs in the image forming apparatus of the user.

In the above-mentioned embodiment, the registration deletion is performed from the terminal apparatus 4, but may be enabled from the image forming apparatus 1. In this case, the browser 22 and the management service application 23 operate in place of the web browser 65, and the operation panel 12 operates in place of the display device 62 and the input device 63.

In the above-mentioned embodiment, the management service application 23 may transmit a setting of the image forming apparatus 1 that does not dynamically change along with the registration request, and the data management unit 42 may receive the setting of the image forming apparatus 1 that does not dynamically change and retain the setting separately from the device information that is periodically acquired. Therefore, in this case, on the server 3, the setting of the image forming apparatus 1 that does not dynamically change is retained as it was at the time of registration without being updated.

In the above-mentioned embodiment, the data management unit 42 may transmit an e-mail indicating the registration completion or the registration deletion completion to a predetermined e-mail address of at least one of the customer and the service person at the registration completion and at the registration deletion completion.

In the above-mentioned embodiment, the identification information for the image forming apparatus 1 within the communication network 2, such as the IP address of the image forming apparatus 1, may be monitored by being included in the device information.

In the above-mentioned embodiment, in a case where the IP address of the image forming apparatus 1 is changed and the server 3 cannot acquire the device information from the image forming apparatus 1, e-mail including a message to that effect may be transmitted to a previously-registered e-mail address (e-mail address of the customer or the service person). In this case, for example, the user may delete the registration of the image forming apparatus 1 temporarily, and may register the image forming apparatus 1 again.

In the above-mentioned embodiment, in a case where the terminal apparatus 4 is connected directly to the image forming apparatus 1 using the universal serial bus (USB) or the like, in place of the operation panel 12 and the browser 22 of the image forming apparatus 1, the terminal apparatus 4 may be used as the user interface for the user at the time of the registration.

What is claimed is:

1. An image forming system, comprising:
an image forming apparatus connected to a communication network; and
a server connected to the communication network,
the image forming apparatus comprising a management service processing unit configured to transmit a registration request for registering the image forming apparatus as a target of a management service to the server when a registration request operation is input through a user interface,
the server comprising a data management unit configured to receive the registration request and register the image forming apparatus that has transmitted the registration request as the target of the management service, wherein:
the management service processing unit periodically collects device information including a state and/or a setting of the image forming apparatus and transmits the device information to the data management unit; and
the data management unit periodically acquires the device information from the management service processing unit and retains the device information.

2. The image forming system according to claim 1, wherein:
the management service processing unit transmits a setting of the image forming apparatus that does not dynamically change along with the registration request; and
the data management unit receives the setting of the image forming apparatus that does not dynamically change, and retains the setting separately from the device information that is periodically acquired.

3. The image forming system according to claim 1, wherein:
the data management unit transmits a transmission request for the device information to the management service processing unit according to a schedule; and
the management service processing unit collects the device information upon receiving of the transmission request for the device information, and transmits the device information to the data management unit.

4. The image forming system according to claim 1, further comprising a terminal apparatus that is connected to the communication network and acquires the device information for the image forming apparatus from the server.

5. The image forming system according to claim 4, wherein the data management unit receives a registration deletion request from the terminal apparatus, and deletes the image forming apparatus associated with a user of the terminal apparatus that has transmitted the registration deletion request from the target of the management service.

6. The image forming system according to claim 1, wherein:
the server further comprises a web server;
the management service processing unit uses a hypertext transfer protocol (HTTP) command to transmit the registration request; and
the data management unit receives the registration request via the web server.

7. The image forming system according to claim 1, wherein:
the user interface comprises a web browser and an operation panel;
the data management unit transmits a response message to the registration request;
the management service processing unit receives the response message; and
the web browser displays the response message on the operation panel.

8. The image forming system according to claim 4, wherein the data management unit creates information viewing page data including the device information in response to a device information viewing request received from one of the terminal apparatus and the image forming apparatus, and transmits the information viewing page data to a web browser of the one of the terminal apparatus and the image forming apparatus via a web server.

9. The image forming system according to claim 8, wherein the data management unit creates information page data including at least one device information item associated with a user that has transmitted the device information viewing request, and transmits the information page data to the web browser of the one of the terminal apparatus and the image forming apparatus.

10. An image forming apparatus, comprising:
a communication interface configured to connect to a communication network and communicate with a server; and
a management service processing unit configured to transmit to the server a registration request for registering the image forming apparatus as a target of a management service when a registration request operation is input through a user interface,
wherein the management service processing unit periodically collects device information including a state and/or a setting of the image forming apparatus and transmits the device information to the server.

11. The image forming apparatus according to claim 10, wherein the management service processing unit transmits a setting of the image forming apparatus that does not dynamically change along with the registration request.

12. The image forming apparatus according to claim 10, wherein the management service processing unit collects the device information upon receiving a transmission request for the device information from the server and transmits the device information to a data management unit.

13. The image forming apparatus according to claim 10, wherein:
the user interface comprises a web browser and an operation panel; and
the web browser displays a message from the server on the operation panel.

14. The image forming apparatus according to claim 10, wherein a terminal apparatus associated with the image forming apparatus acquires from the server the device information for the image forming apparatus.

15. The image forming apparatus according to claim 14, wherein the image forming apparatus associated with the terminal apparatus is deleted from the target of the management service upon the terminal apparatus transmitting a registration deletion request to the server.

16. An image forming apparatus management method, comprising:
transmitting a registration request for registering an image forming apparatus as a target of a management service to a server when a registration request operation is input through a user interface of the image forming apparatus;
receiving, by the server, the registration request and registering the image forming apparatus that has transmitted the registration request as the target of the management service; and
periodically collecting device information including a state and/or a setting of the image forming apparatus and transmitting the device information to the server.

17. The image forming apparatus management method according to claim 16, further comprising:
transmitting, by the image forming apparatus, a setting of the image forming apparatus that does not dynamically change along with the registration request; and
receiving, by the server, the setting of the image forming apparatus that does not dynamically change, and retaining the setting separately from the device information that is periodically acquired.

18. The image forming apparatus management method according to claim 16, further comprising:
transmitting, by the server, a transmission request for the device information to the image forming apparatus according to a predetermined schedule; and
collecting, by the image forming apparatus, the device information upon receiving the transmission request for the device information, and transmitting the device information to the server.

19. The image forming apparatus management method according to claim 16, further comprising:
acquiring, by a terminal apparatus that is connected to a communication network, the device information on the image forming apparatus from the server.

20. The image forming apparatus management method according to claim 16, further comprising:
receiving, by the server, a registration deletion request from a terminal apparatus, and deleting the image forming apparatus associated with a user of the terminal apparatus that has transmitted the registration deletion request, from the target of the management service.
